(19) United States
(12) Patent Application Publication
(10) Pub. No.: US 2006/0090783 A1
(43) Pub. Date: May 4, 2006

(54) Multifunctional walking stick

(76) Inventor: Chan King-Fai, Dongguan Shi (CN)

Correspondence Address: BOURQUE & ASSOCIATES, P.A., 835 HANOVER STREET, SUITE 303, MANCHESTER, NH, 03104, US

(21) Appl. No.: 11/247,322

(22) Filed: Oct. 11, 2005

(30) Foreign Application Priority Data
Oct. 10, 2004 (CN) 04108201.4

(51) Int. Cl. A61H 3/00

(52) U.S. Cl. 135/67; 135/65

(57) ABSTRACT

An improved walking stick has following improvements: The focus of its electric torch can be adjusted by a finger at any time for pinpointing a small location or for shining a wide area. The stem is adjustable by double-safe construction for keeping adjusted stem firmly in position and is more solid and stable than any prior art after adjusting. The tiny-article carrying box is detachable, the user can attach it on the stick or detach it from the stick freely. Besides, boxes with different sizes and shapes can be prepared for different choices. A soft PTR plastic jacket is molded on the whole handle for increasing comfortable of gripping with maximum friction coefficient. A horn type cover for beeper is added for enhancing the sound effect therefore the beeper sounds loudly than the same beeper without such acoustic cover. And will sound more loudly when the horn opening is approached by something.

### FIELD OF THE INVENTION

This invention relates to walking sticks, particularly relates to walking sticks with multi-functions. (A45B 3/00)

### BACKGROUND OF THE INVENTION

Walking sticks were used by human for helping walk. The main function of any walking stick is to partially support the walker's body weight through the hand. In doing so, the walker can walk farther in distance and more stable than one who has no walking stick in his hand. And the other functions which are indirectly helping walk including to scare dogs, snakes, etc, etc. Barking dogs usually fear a man with a stick in his hand. Snakes in the grass near the walker will be scared and run away when walking stick perturbs the calm grass land. Therefore, nowadays, not only senior people using walking sticks, strong sportsmen also using walking sticks in their hiking.

In present time, electric torch and flashing light are commonly equipped to walking sticks for lighting up the road and warning the others. They are U.S. Pat. No. 4,625,742; U.S. Pat. No. 5,588,735; U.S. Pat. No. 5,810,466; DE 201 10 651 U1; CN 2092897U; CN 2577644Y; CN 2693054Y. Some of the patents put beeper into walking stick for announcing the location of the walker who using the walking stick. They are GB 2404144 A; CN 2167582Y; CN 2188294Y. Some of the patents put storage box into walking stick for carrying additional tiny articles. They are DE 299 00 220 U1; CN 2629502Y; CN 2599966Y. Some of the patents has telescopic stem (shaft). They are CN 2271282Y; HK 1066400A. All disclosed multifunctional walking sticks have following shortcomings:

1) The electric torch of all prior arts is too simple, it's focus can not be adjusted. When a user walking in the dark, he sometimes wants to pin-point a small location, and sometimes wants to spray the light in a wide area. Therefore, no prior art mentioned above can perform this function.

2) Most of the prior arts have no adjustable stem (shaft) for suiting the height of the user. This will cause the user very uncomfortable in a long journey. A walking stick with unsuitable length will cause the arm painful in walking. Some of the prior arts has telescopic stem (shaft) for adjusting the stick length. While there only was a locking ring using friction to fix both inner and outer stems in position, when an impact (or a sudden burden) takes place, or some lubrication liquid (including the water) is existing between the surfaces of inner and outer stems, the inner stem will not be locked firmly by the locking ring and the stretched telescopic shaft will be pushed in. It is very dangerous for an user when the walking stick suddenly becomes shorter in use.

3) All prior arts have their tiny article carrying box un-detachable and un-changeable. It is obvious that sometimes the user needs a carrying box attached on the stick and sometimes the user needs not a carrying box attached on the stick. Besides, sometimes the user needs a bigger carrying box and sometimes the user needs a smaller box, etc, etc.

4) Most of the prior arts did not consider the friction between the stick handle and the grip of the user. If there is no enough friction between the stick handle and the grip of the user, the user will spend more strength for gripping the handle and this will cause the user exhausted quickly. And uncomfortable handle will cause the user's hand pains.

5) All prior arts did not consider acoustics, the beeper (or sounder) was randomly installed into the stick handle and did not consider acoustic requirement. Therefore, the sound from the beeper was muffled by the housing. And no increasing effect can be gained.

### SUMMARY OF THE INVENTION

The object of this invention is to provide an improved multifunctional walking stick from the prior arts. According to this invention, the walking stick of this invention will be improved in following aspects:

1) The focus of its electric torch is now adjustable by a finger at any time. In doing so, the torch light can be converged for pinpointing a small location, it can also be dispersed for shining a wide area.

2) The stem (shaft) is now adjustable by double-safe construction for keeping adjusted stem (shaft) firmly in position. In doing so, the stem (shaft) is now more solid and stable than any prior art after adjusting the shaft length.

3) The tiny-article carrying box is now detachable. In doing so, the user can attach it on the stick or detach it from the stick freely. Besides, since the carrying box is detachable, boxes with different sizes and shapes can be prepared for different choices.

4) A soft PTR plastic jacket is now molded on the whole handle. In doing so, the handle is now comfortable to be gripped with maximum friction coefficient.

5) A horn type cover for beeper is designed for enhancing the sound effect. In doing so, the same beeper sounds loudly than any beeper without such acoustic cover. And will sound more loudly when the horn opening is approached by something (for example, by the hand).

For achieving above mentioned object, the multifunctional walking stick of this invention comprising: A screw-in type reflector with knurling rim, for adjusting the focus of the electric torch light beam. A push-button type locking pin in the inner tube and a plurality of matching holes in the outer tube for selectively fixing the whole stem in desired length. A screw-in-tight screw cap with knurling outer surface in the lower end of the outer tube for tightly embracing the outer tube onto the inner tube to avoid any loose takes place between the outer tube and the inner tube after length adjustment. A detachable tiny-article carrying box can be attached on the upper stem by clamping brackets. A soft PTR plastic jacket molded on assembled handle housing for increasing both the tenderness of the handle and the friction coefficient between the stick handle and the grip of the user. An integral horn type cover is cooperated with the beeper to form the increasing effect of the sound.

### BRIEF DESCRIPTION OF THE DRAWINGS

FIG. 1 is a sectional drawing of the multifunctional walking stick of this invention.

FIG. 2 is an end view from the left of FIG. 1.

FIG. 3 is a sketch for showing the construction of locking cap used in this invention.

FIG. 4 is an enlarged view for showing detail construction of the handle.

FIG. 5 is an enlarged view for showing detail construction of the warning flash.

FIG. 6 is the circuit diagram of the multifunctional walking stick of this invention.

### DETAILED DESCRIPTION OF THE EMBODIMENTS

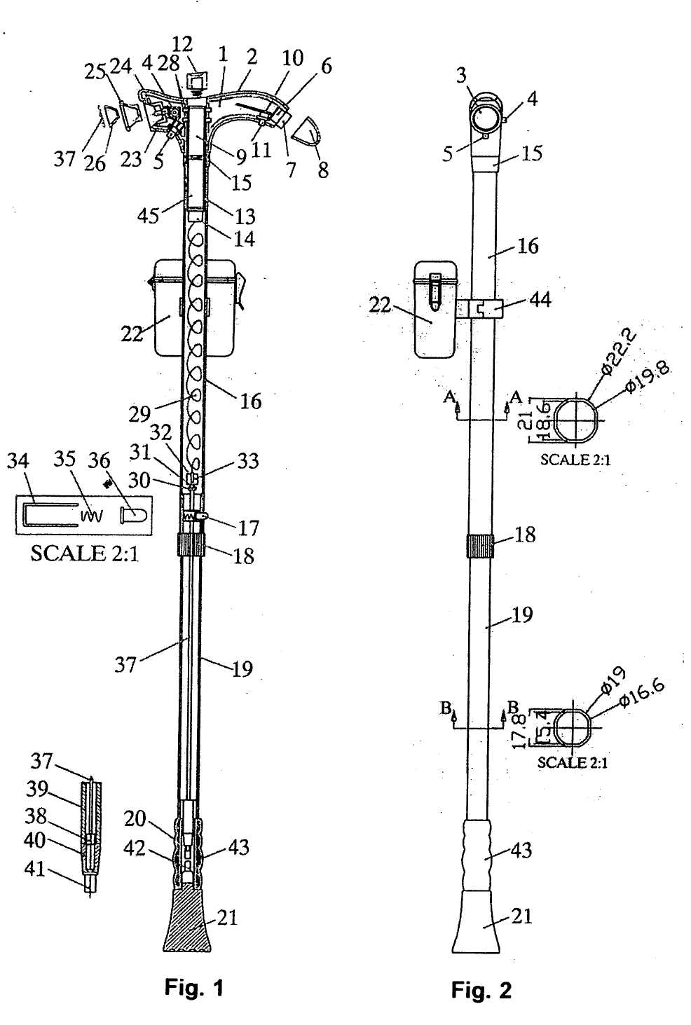

Refer to FIG. 1 the sectional drawing for showing most important parts of the multifunctional walking stick of this invention, and also FIG. 2 the end view of FIG. 2, In FIG. 1 and FIG. 2, 1 is the handle (assembly) of the walking stick, usually made of plastic, in two halves. 2 is the PTR soft plastic coating molded on the outside surface of said handle 1. 3 is the electric torch (assembly). 4 is the control switch of said electric torch 3. 5 is the control switch for flash light 20 and warning beeper 7. 6 is the socket for warning beeper 7. 8 is the horn-type cover of warning beeper 7. 9 and 45 are the upper and lower batteries, in this invention, two AA type batteries are used. But it is obvious that in practice, any suitable type and number of battery can be used. 10 is the PCB, it is used for optimizing the control of both beeper 7 and the flashing light 41, 42. PCB 10 is not a must and will be described later. 11 is the terminal for battery recharge purpose located on the PCB 10 can be accessed outside the handle 1. 12 is the cover of battery compartment. 13 is the battery compartment, cylindrical in shape. 14 is the wire connecter. 15 is the screw connecter for connecting the handle 1 and the outer stem 16. 17 is a plurality of holes for adjusting the height of the whole stem. 18 is the locking cap for securing the inner stem 19 firmly in the outer stem 16. 21 is the re-changeable rubber tip. It can be simply pull out and plug in the end hole of the transparent plastic tube 43. 22 is the carrying box for receiving tiny articles. upper (outer) stem (shaft) of the walking stick. 18 is the lower (inner) stem (shaft) of the walking stick. 13 is the detachable tiny-article carrying box. In this invention, box 13 is fixed on outer stem 16 by clamping bracket 44.

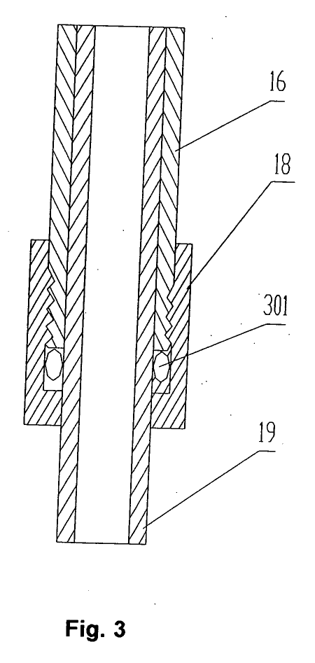

FIG. 3 is a drawing for showing the construction of locking cap used in this invention. In prior arts, there was no means to keep the inner stem 19 tightly hold by the outer stem 16. While in this invention, the lower end of the outer stem 16 is threaded, and a locking cap 18 has the matching thread in its inside surface is used. A plastic ring 301 is placed between the tube end of outer stem 16 and bottom of locking cap 18. Once the cap 18 is screwing on the threaded end of outer stem 16, the bottom of said cap 18 will press the ring 301 and will cause it bulging transversely. Thus the outer stem 16 and the inner stem 19 will become a solid one piece. Before sliding the inner stem 19 in the outer stem 16, the cap 18 must be loosen first.

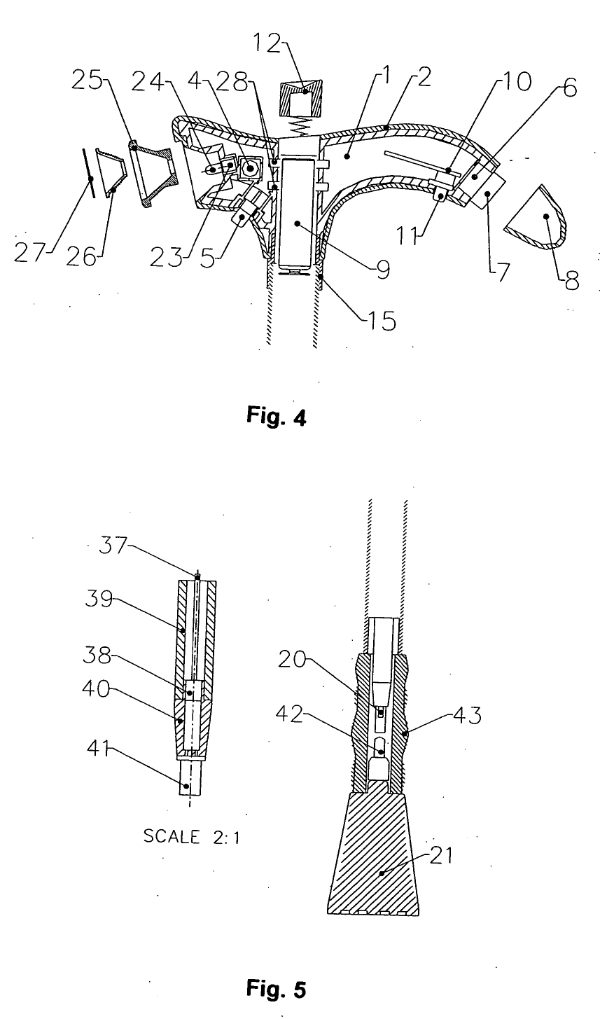

For details of the electric torch assembly 3, please refer to FIG. 4, 23 is the socket for installing the lamp (bulb) 24. 25 is the adjusting cup. The outer surface of the cylindrical portion has threads, the rim of the opening has knurling, therefore, when the cup 25 is turned by knurling rim, it will be stretched out or withdrawn in its matching screw socket. 26 is the reflector received in said adjusting cup for focusing the light from the lamp (bulb) 24. Therefore, slightly turn the knurling rim of the adjusting cup 25 will cause the reflector 26 forward or backward, thus the light from the lamp (bulb) 24 will be converged for pinpointing a small location, or dispersed for shining a wide area. 27 is the lens. 28 is the electric terminals.

Now return to FIG. 1, in this invention, the outer stem 16 and inner stem 19 are connected telescopically. A row of holes 17 are presented on the outer stem 16 for adjusting the total length of the whole stem (outer stem 16 and inner stem 19). A push-button type locking pin 36 installed in the inner stem 19 can stretch out through one of said holes 17 for fixing the length formed by both stems 16 and 19. Said pin 36 is biased by a spring 35 and both said pin 36 and spring 35 are placed in a cylindrical cup 34. Said cup 34 is then glued in the inner stem 16 as shown. For matching the locking pin 36 into selected hole 17, the user must push the locking pin 36 beyond the hole 17, and then slide the inner stem 19 until the pin 36 matching into next hole 17. When sliding the inner stem 19, the inner space of outer stem 16 will be changed accordingly, therefore, the electric wires 29 in this space were curved for suiting variable length. While in the inner stem 19, the length of the electric wires are unchanged, so straight wires 37 can be used. Said curved wires 29 are running from upper connector 14 to the lower connector 33. 32 is the lock for said curved wires 29. 30 is the male plug of said curved wires 29. 31 is the plug for straight wires 37. For avoiding the relative rotation takes place between the inner stem 19 and the outer stem 16, both inner stem 19 and outer stem 16 are manufactured with a section not round. In this invention, octagonal aluminum tubes are used.

Now refer to FIG. 1 and FIG. 4. This enlarged view in FIG. 4 showing more details of handle 1 assembly. Particularly the beeper-cover pair. Simply speaking, the integral horn type cover acts as a hearing aids horn 100 years ago. In normal use, the sound from the beeper will converged by the horn and will be louder than the beeper without the horn. In some case, if a thing (for example, a hand) is approaching the opening of the horn within certain close distance, the sound from the beeper will further increasing. This function can be used to scare some trespasser such as a barking dog, etc. Of course, the sound from the beeper will also be the signal for rescue when the stick-user is in an invisible location.

Now refer to FIG. 1, FIG. 2 and FIG. 5. This enlarged view in FIG. 5 represents the warning flash surrounded by the transparent plastic tube 43. 39 and 40 are two plastic tubes, one is in cylindrical one in conical. 38 is the male plug of the straight wires 37. 41 and 42 are two LED lamps (bulbs). This flashing light emitted from the two LED lamps is used to show the location of the stick user, and also can be used to warning any thing approaching the stick user, such as snake etc. For getting the farthest visibility, red LED is recommended. While LED with other colors may also be used. This flashing light can be switched off in the day time.

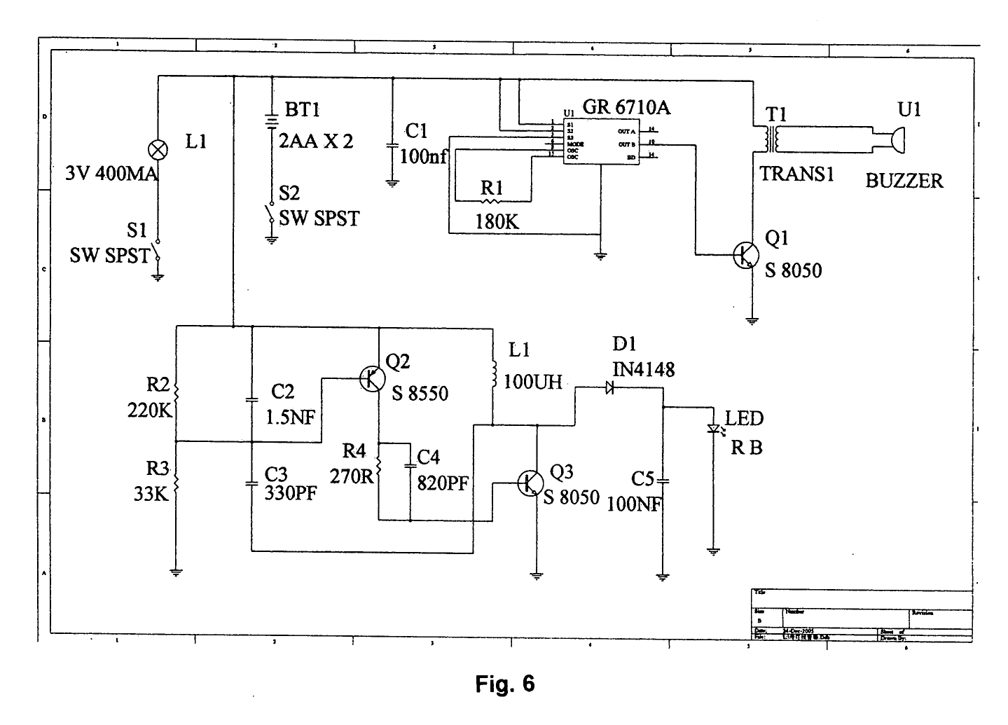

Now refer to FIG. 6. As mentioned above, a PCB is used in this invention for optimizing the control of both flashing light 41, 42 and the beeper 7. If the PCB is not used, when the energy is switched on, both the beeper 7 and the LED 41, 42 will sound/flash continuously. Though some kind of LED lamps can flash without PCB control, but the frequency of flashing is unsettle able. By using a PCB, the flashing frequency of LED, and the intermittence of sound can be settled optimistically. And the sound of the beeper can also be controlled in an intermittent type. In doing so, not only the energy can be saved, but also the sound type and the flashing type can be settled per public habit. For example, the frequency for both sound and light can imitate a police car. Therefore, using a PCB as shown in FIG. 6, two AA type batteries can run all electricity consuming functions (electric torch, beeper and flashing LED) for four hours. Since it is not necessary to use said three functions at the same time, for example, if the user is walking in the dark, the electric torch must be switched on, while the flashing light is no more necessary. If the user comes to a stop, he can switched on the flashing light for tell the others his location and the electric torch can be switched off.) so two AA type batteries can selectively run said all electricity consuming functions of this invention in eight hours.

In FIG. 6, both beeper circuit and LED circuit are controlled by a switch, while in practical use, separate switches can be used for control each circuit. In doing so, the energy can be further saved and the batteries can be lasting longer.

1. An improved multifunctional walking stick comprising:
A screw-in type reflector with knurling rim, for adjusting the focus of the electric torch light beam;
A push-button type locking pin in the inner tube and a plurality of matching holes in the outer tube for selectively fixing the whole stem in desired length;
A screw-in-tight screw cap with knurling outer surface in the lower end of the outer tube for tightly embracing the outer tube onto the inner tube to avoid any loose takes place between the outer tube and the inner tube after length adjustment;
A detachable tiny-article carrying box can be attached on the upper stem by clamping brackets;
A soft PTR plastic jacket molded on assembled handle housing for increasing both the tenderness of the handle and the friction coefficient between the stick handle and the grip of the user;
An integral horn type cover is cooperated with the beeper to form the increasing effect of the sound.

2. An improved multifunctional walking stick as in claim 1, wherein additional PCB is used to settle frequency of both beeper sound and flashing light per public habit.

3. An improved multifunctional walking stick as in claim 2, wherein a terminal for recharging the batteries is located on the PCB and can be reached outside the handle.

4. An improved multifunctional walking stick as in claim 2, wherein separate switches can be used for controlling each beeper and LED circuit.

5. An improved multifunctional walking stick as in claim 1, wherein said electric torch, the covered beeper and the PTR soft jacket formed the handle of the walking stick, and said handle is connected to the stem (shank) by screw connector.

6. An improved multifunctional walking stick as in claim 1, wherein a re-changeable rubber tip can be simply pull out and plug in from/to the end hole of the transparent plastic tube.

7. An improved multifunctional walking stick as in claim 1, wherein said screw-in-tight screw cap has an inner plastic ring abutting the end face of the outer stem.

8. An improved multifunctional walking stick as in claim 1, wherein said matched outer and inner stems are manufactured with a section not round for preventing relative rotation.

9. An improved multifunctional walking stick as in claim 8, wherein said section is octagonal.

10. An improved multifunctional walking stick as in claim 8, wherein said stems are made of aluminum tubes.
